(19) United States
(12) Patent Application Publication
(10) Pub. No.: US 2005/0071180 A1
(43) Pub. Date: Mar. 31, 2005

(54) Computerized export control system for online information

(76) Inventors: Mark B. Richman, Chicago, IL (US); Teri L. Rowe, Gilbert, AZ (US); Jeff D. Young, Wheaton, IL (US); Lawrence A. Grenon, Phoenix, AZ (US)

Correspondence Address: MOTOROLA, INC., 1303 EAST ALGONQUIN ROAD, IL01/3RD, SCHAUMBURG, IL, 60196, US

(21) Appl. No.: 10/675,845

(22) Filed: Sep. 30, 2003

(51) Int. Cl. G06F 17/60

(52) U.S. Cl. 705/1; 705/26

(57) ABSTRACT

A method used by an computerized export control system (105) for online information such as documents allows log-on (210) by a user only when the user has a verified citizenship that is recorded and available to the computerized export control system. The computerized export control system records (330) a user entered export control classification number (ECCN) for the new document, when the ECCN matches an ECCN on a recorded list of valid ECCN's. A document is recorded as being commerce restricted when at least one of the following statements is true (705, 710): no export classification control number (ECCN) is recorded for the document, and at least one recorded ECCN is export controlled. The system automatically notifies an Export Control Specialist (365) when a document is submitted that has an export workflow restriction.

### BACKGROUND

Many governments have regulations as to what information and products can be exported. Exporting of information can be easily accomplished over information networks. A conventional method for a company to comply with the export control regulations has been to ask an employee that is knowledgeable of the information or product to determine a classification for that item from a government classification list. Then, access to the information or product by any person should be controlled, the control based upon the classification of the information or product, the citizenship of the person, and the location of the person. For high technology information stored in an information network, processes for controlling access to such information have been lacking, typically being implemented as written policies and without controlled reviews, often leaving it up to persons with incomplete or no knowledge of the export regulations to allow release of such information, with a resulting risk that the information gets released incorrectly.

With the proliferation of high technology information embodied in documents such as patent disclosures that are stored in intranet based systems during the editing and approval cycles, and the increased diversity of people from all over the world having general access to the intranet based systems, an improved technique for complying with such government regulations is needed that provides adequate assurance of compliance.

### BRIEF DESCRIPTION OF THE DRAWINGS

The present invention is illustrated by way of example and not limitation in the accompanying figures, in which like references indicate similar elements, and in which:

FIG. 1 is a block diagram of computer systems that include an computerized export control system for online information (CECSOICECSOI), in accordance with an embodiment of the present invention.

FIGS. 2 and 3 are flow charts that show steps of a method for logging a user onto the CECSOI and for the user to initiate a new disclosure document, in accordance with an embodiment of the present invention.

FIGS. 4 and 5 are flow charts that show steps of a method for entry participants to review, acknowledge, modify, and approve an invention disclosure used in the CECSOI, in accordance with an embodiment of the present invention.

FIGS. 6 to 9 are flow charts that show steps of a method used in the CECSOI for determining user export restrictions for an invention disclosure that has been submitted but not entered, in accordance with an embodiment of the present invention.

FIG. 10 is a flow chart of a method for presenting invention disclosure information to a user, in accordance with an embodiment of the present invention.

FIG. 11 is a flow chart of a method for an Export Control Specialist to resolve a user export restriction for an invention disclosure is shown, in accordance with an embodiment of the present invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION OF THE DRAWINGS

Before describing in detail the particular computerized export control system in accordance with the present invention, it should be observed that the present invention resides primarily in combinations of method steps and apparatus components related to computer systems. Accordingly, the apparatus components and method steps have been represented where appropriate by conventional symbols in the drawings, showing only those specific details that are pertinent to understanding the present invention so as not to obscure the disclosure with details that will be readily apparent to those of ordinary skill in the art having the benefit of the description herein.

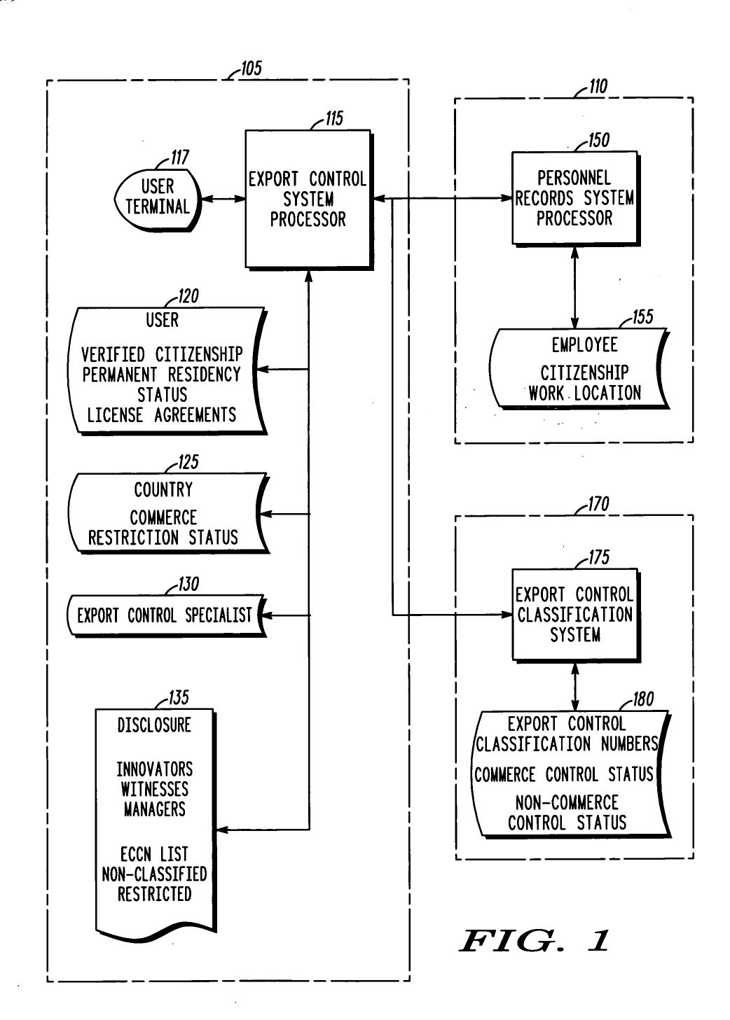

Referring to FIG. 1, a block diagram of computer systems is shown, in accordance with an embodiment of the present invention. The computer systems comprise an computerized export control system for online information (CECSOI) 105, a personnel records system 110, and an export control classification system 170. The CECSOI 105 comprises an CECSOI processor 115 and a plurality of network connected (either a local area network or the world wide web, via secure links) user computers, of which one computer 117 is shown in FIG. 1. The user computers are client devices in the CECSOI 105. The CECSOI 105 is uniquely programmed to provide export controlled online submission, drafting, approval, and entry of online information that is most typically in the form of documents that are generated for reading by people, but could alternatively be other types of information, such as data tables or programmed instruction sets in the form of source and/or object code. All such information will be referred to herein as documents The CECSOI 105 is a system that is accessible to users in a number of countries, and controls the availability of online information so that only users who meet the export control requirements of a primary country, which in this example is the United States of America, can access the information or the titles of the information when the information is deemed inappropriate to export to certain other countries. Records stored by the CECSOI 105 include user records 120, country records 125, Export Control Specialists 130, and the online information, which is generally exemplified hereafter by invention disclosure documents 135. Each user record 120 may include the following attributes associated with the user: a verified citizenship, a permanent residency status in the primary country, and one or more license agreements. Each license agreement may be associated with one or more of the documents controlled by the CECSOI 105, and may give permission for exportation of the document to the user, who could otherwise be restricted from seeing or using the document. The country record 125 includes a list of countries that are expected to be used as citizenship and work countries of users, and in association with each such country, the system may store a commerce restriction status for documents that describe technologies that are within a set of technical classifications that are deemed sensitive for commerce reasons (in the USA, the determinations are made by the Department of Commerce). The entire set of technical classifications used in the USA, including both non-sensitive and sensitive classifications, are called export control classification numbers (ECCN's). The export control status for each technical classification is herein called the commerce control status. Each document can be characterized by one or more ECCN's. When any of the ECCN's have a commerce control statues of restricted, the exportation of the document is restricted, which can also be expressed as being subject to ECCN control. All documents subject to ECCN control are restricted from being exported to one set of countries; these countries have their commerce restriction status set to restricted in the country record. The Export Control Specialist record is a list of persons who are knowledgeable in export control matters and are responsible for manually resolving exceptions that may arise in the CECSOI during the processing of invention disclosures or other technical documents.

The CECSOI 105 includes invention disclosures 135 in various stages of drafting and approval. Included in the many items recorded for each disclosure are the names and computer identities of users who are called entry participants. (As used herein, “recorded” means stored in computer memory, not on paper). They include innovators, witnesses, and a manager, all of whom must approve the document before it is entered into a next stage of processing. (Witnesses and or managers may not be needed for some documents, and those called innovators for invention disclosures may be more appropriately referred to as authors for other types of information). Each entry participant's role is recorded in association with (alternatively stated herein as being “recorded for”) the invention disclosure. ECCN's may be recorded for each disclosure. In some instances, this will be blank because the best ECCN has not been identified by a user. A non-commerce restriction is captured at the time of ECCN entry by a user; although it may be determined by the ECCN number, it does not necessarily relate to the set of countries used for commerce restrictions, and is used differently within the CECSOI 105. This status is set to restricted when a user identifies the document as being subject to export restrictions for reasons other than a commerce restriction.

The CECSOI 105 is coupled to a personnel records system processor 150 of the personnel records system 110 to access certain employee data in the records 155 of employees who are users of the CECSOI system 105. The data of interest is the user's citizenship and the user's normal business location (which is used to determine the user's work country). However, this data, particularly the user's citizenship, may not always be found in the employee records 155.

The CECSOI 105 is coupled to the export control classification system 170 to access ECCN's and their commerce control status from the ECCN records 180. The export control classification system 170 system may be one, for example, operated by the government and the information may available over the world-wide-web. A non-commerce control status for each ECCN may be found at the same web-site, or at a different web-site. The non-commerce control status may also be dependent on a technology classification that is different than the ECCN system. In the USA, restrictions for commerce controls are substantially more common than those for non-commerce controls, except perhaps in some industries (e.g., weapons).

In an alternative embodiment, records such as the ECCN records 180 may be located within the CECSOI 105 and periodically updated as an administrative function. The personnel records system 110 and the CECSOI system 105 could, of course, each be a distributed system running on more than one computer, or could both be running on the same computer, as is well known in the art. The arrangement of the records shown in FIG. 1 is conceptual; there are myriad techniques for associating attributes and information that are well known in the art.

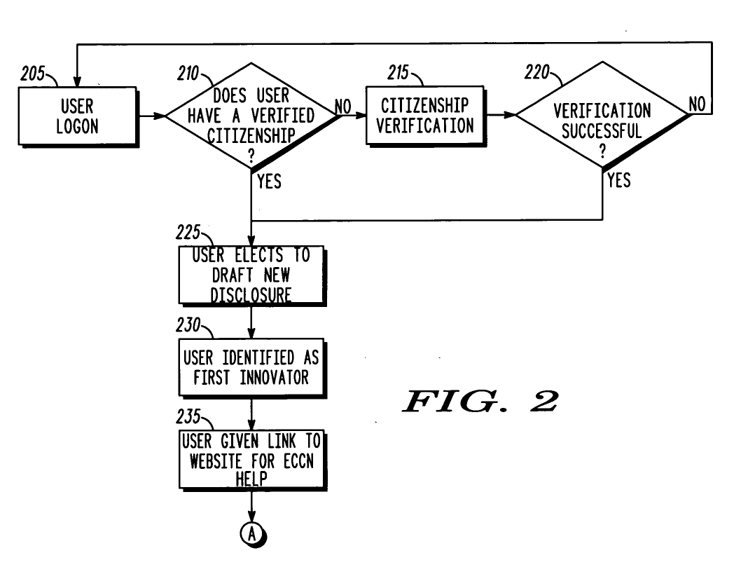

Referring to FIG. 2, a flow chart shows steps of a first portion of a method for logging a user onto the CECSOI and for the user to initiate a new disclosure document, in accordance with an embodiment of the present invention. At step 205, the user goes to a log-on page for the CECSOI and enters the normal log-on information for the system. When, at step 210, the user does not have a verified citizenship recorded in the CECSOI, a citizenship verification page is presented to the user, at step 215.

The CECSOI is uniquely designed to allow log-on by the user to the computerized export control system only when the user has a verified citizenship that is recorded and available to the CECSOI. In one method of doing this, a legal consequences alert is presented to the user (indicating, for example, that attempts to falsify the user's citizenship can lead to dismissal), and a list of countries is presented to the user. The CECSOI accepts a citizenship selection from the user, and records the citizenship selection as the user's verified citizenship. The method may be augmented by denying an online change of the verified citizenship from a country that is recorded as being restricted (i.e., a country that has a commerce restriction status of restricted, or a country that is known to be on a list of non-commerce restrictions) to one that is recorded as being not restricted. As a part of the citizenship verification 215, the CECSOI also requires the user to identify a permanent residency status in the primary country when the citizenship selection is other than the primary country, and records that information with the verified citizenship in the user records 120. In other embodiments, the verified citizenship and/or the permanent residency information can be obtained from the personnel records system. This alternative method could be substituted for the one in which the user selects a country and identifies the user's own permanent residency status, when the citizenship and permanent residency information in the personnel records system is rigorously maintained.

When the user's verified citizenship is successfully recorded in the CECSOI at step 220, the user is presented an option to begin drafting a new disclosure at step 225. A record for the new disclosure is opened in the CECSOI and the user is recorded as being the first innovator for the disclosure. At step 225 the user is provided the ability to review descriptions of export control classification numbers, so that the user may select one or more that most accurately characterize the new disclosure. This may be a link to a government maintained list of ECCN's.

When a user is not successful in recording a verified citizenship at step 220, then the user must attempt to log-on again, at step 205.

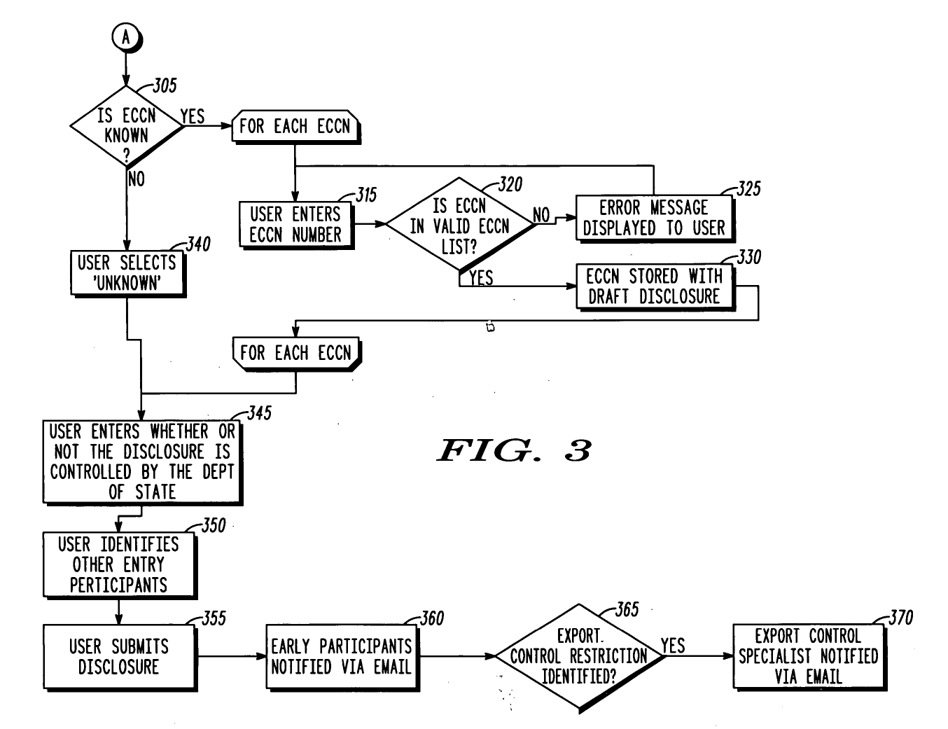

Referring to FIG. 3, a flow chart shows steps of a second portion of the method for logging a user onto the CECSOI and for the user to initiate a new disclosure document, in accordance with an embodiment of the present invention. At step 305, when the user is able to identify at least one ECCN that is applicable to the new disclosure, a set of steps is repeated for each of the ECCN's the user identifies. In accordance with one embodiment of the present invention, the user is presented no ECCN information (i.e., no list of ECCN numbers). This method may be used in situations where most users are unfamiliar with ECCN's, to avoid the identification of inapplicable ECCN's by unskilled users. In another embodiment, a list of ECCN's and their descriptions could be made available to the user, from which the user could select one or more ECCN's. Such a list may comprise a link to the ECCN system 170. At step 315 the user enters the identified or selected ECCN number. At step 320, the CECSOI checks that the entered ECCN is valid, for example using the ECCN record 180. When the entered ECCN is not valid, the user is alerted by an error message at step 325, and the entry is not recorded by the CECSOI. When the entered ECCN is determined to be valid at step 320, the ECCN is recorded in the new disclosure, at step 330. When the user does not identify any ECCN for the new disclosure, at step 340, or when the last ECCN has been stored with the disclosure at step 330, the user is directed to identify whether or not the new disclosure is export restricted due to reasons other than the ECCN control imposed by the Commerce department. As mentioned above, this non-commerce determination may depend on ECCN's selected for the new disclosure, but is handled differently by the CECSOI. The non-commerce restriction is recorded for the new disclosure. In one embodiment of the present invention, the non-commerce restriction status is set to non-restricted, and no list of non-commerce restrictions is presented to a user. This method is used when it is expected that users dealing with non-commerce restrictions will be aware of such restrictions for the type of information they are submitting and entering. Next, the user (the first innovator in the example of an invention disclosure) identifies other entry participants at step 350. These include other innovators and witnesses. The CECSOI records these entry participants in the new disclosure, and from the list of innovators, also determines a manager of the innovators as an additional entry participant, and records the manager in the new disclosure. The user may then submit the new disclosure at step 355, at which time the CECSOI generates notifications which may be in the form of emails to the other innovators at step 360 so they may collaborate in drafting the new disclosure. At step 360 the CECSOI also generates notifications to the witnesses so they may electronically sign the disclosure as witnesses. At step 365 the CECSOI makes a determination as to whether the disclosure is subject to any export restrictions, and if so, an Export Control Specialist is selected from the Export Control Specialist record 130. For example, one of the entry participants may have a user export restriction for an invention disclosure, in which case the CECSOI determines a department number of the user from the personnel records system, and uses the department number to select an Export Control Specialist assigned to the department.

At step 370 the selected Export Control Specialist is notified, such as by email, of the export restriction (also called an export workflow restriction), along with the nature of the restriction. The disclosure is subject to an export restriction when any entry participant for the disclosure is subject to an export restriction for the disclosure (this is termed a user export restriction). User export restrictions are explained in more detail below, with reference to a description of how user access to disclosure is controlled.

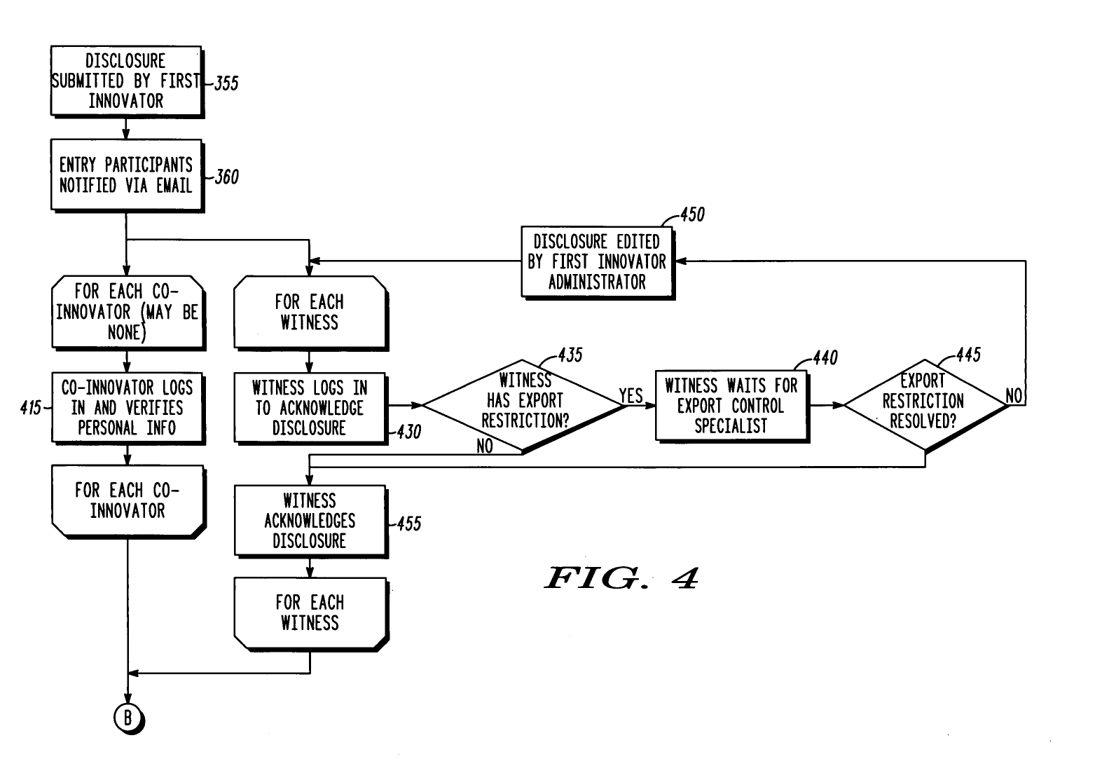

Referring to FIG. 4, a flow chart shows steps of a first portion of a method for entry participants to review, acknowledge, modify, and approve an invention disclosure used in the CECSOI, in accordance with an embodiment of the present invention. When these actions have been completed by the entry participants, the invention disclosure is entered as a completed, approved document that is released for review by other persons who have appropriate export clearance. For example, patent committee members may be alerted to access the invention disclosure after it is entered, in order to assess its value as a basis for a patent application. When the invention disclosure has been submitted at step 355, the entry participants are notified at step 360 (see FIG. 3). For the invention disclosure to be entered as a completed, approved document, each innovator other than the first innovator (if any) must log on to the CECSOI, establish a verified citizenship in the CECSOI if they don't already have one, and establish a permanent residency status when they are not citizens of the primary country, after which they may approve or propose edits to the invention disclosure at step 415. Also, for the invention disclosure to be entered, each witness must acknowledge the disclosure. A set of steps is used for each witness. At step 430, a witness logs on to the CECSOI. This requires that the witness have an authenticated citizenship as described above. When the witness is determined to have a user export restriction at step 435, the Export Control Specialist would have been notified at step 365 (FIG. 3) and the witness must await resolution of the export restriction at step 440. When the restriction is resolved at step 445 by the Export Control Specialist, the witness may then acknowledge the invention disclosure at step 455. When, however, the user export restriction cannot be resolved in a timely fashion, the witness can be removed and replaced by a recommended substitute on the invention disclosure at step 450 by an CECSOI administrator.

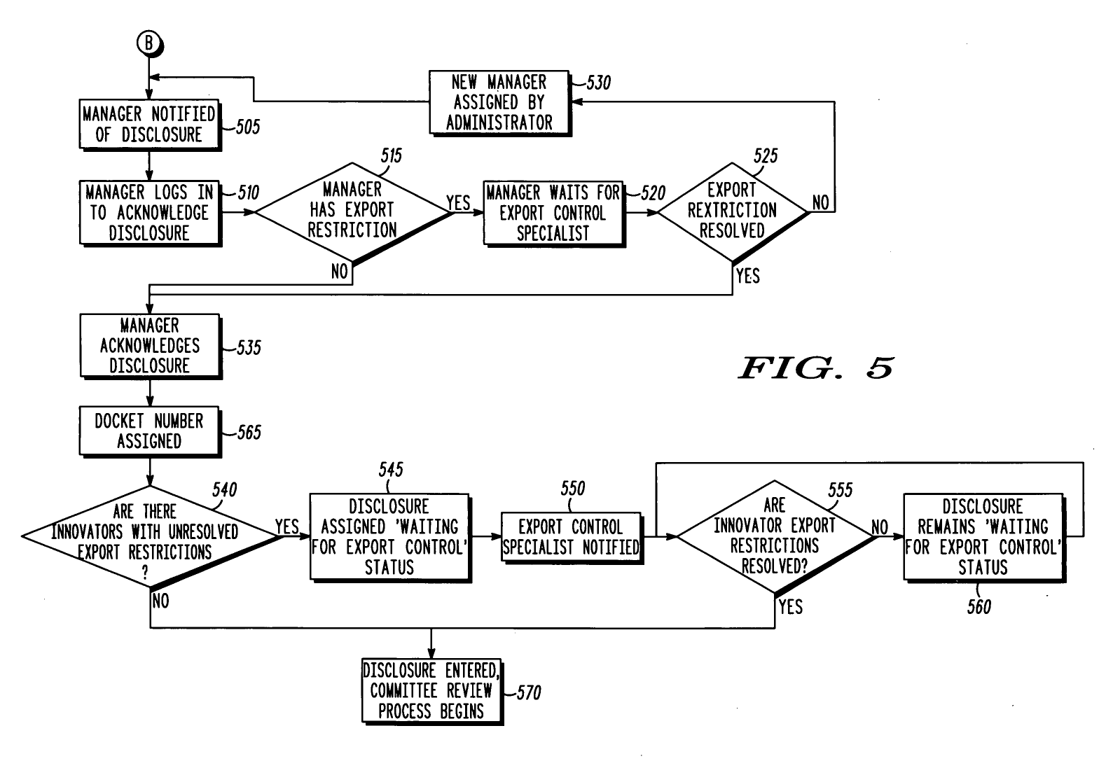

Referring to FIG. 5, a flow chart shows steps of a second portion of the method for entry participants to review, acknowledge, modify, and approve an invention disclosure, in accordance with an embodiment of the present invention. When the innovators and witnesses have acknowledged the invention disclosure, the manager is automatically notified, such as by email, that the invention disclosure is ready for his review, at step 505. At step 510, the manager logs on to the CECSOI. This requires that the manager have an authenticated citizenship as described above. When the manager is determined to have a user export restriction at step 515, the Export Control Specialist would have been notified at step 365 (FIG. 3) and the manager must await resolution of the export restriction at step 520. When the restriction is resolved at step 525 by the Export Control Specialist, the manager may then acknowledge the invention disclosure at step 535. When, however, the user export restriction cannot be resolved in a timely fashion, the manager can be removed and replaced by the next level manager on the invention disclosure at step 530 by an CECSOI administrator, and the process continues at step 505. After the manager acknowledges the invention disclosure at step 535, the CECSOI assigns a new docket number at step 565 and determines whether there are any innovators that have user export restrictions for the invention disclosure at step 540. When there are one or more innovators that have user export restrictions, the invention disclosure is placed into a status of Waiting for Export Control at step 545 and a notification is sent to the Export Control Specialist at step 550 indicating the innovators whose user export restrictions prevent the invention disclosure from being entered. While any export restrictions for innovators remain on the invention disclosure at step 555, the invention disclosure is held in the status of Waiting for Export Control at step 560, until all export restrictions for innovators are determined to have been removed at step 555, at which time the invention disclosure is entered, meaning it is added to a queue of documents at step 570 for a committee review process Also, when no export restrictions for innovators are determined to exist at step 540, the invention disclosure is entered at step 570. In other embodiments of the CECSOI for which documents other than invention disclosures are controlled by the CECSOI, the entry participants could be authors of a technical paper. There may be witnesses or a manager. When the export restrictions are resolved with the involvement of an Export Control Specialist, if needed, the document is entered and ready for wider distribution to users for whom there are no export restrictions for viewing the document.

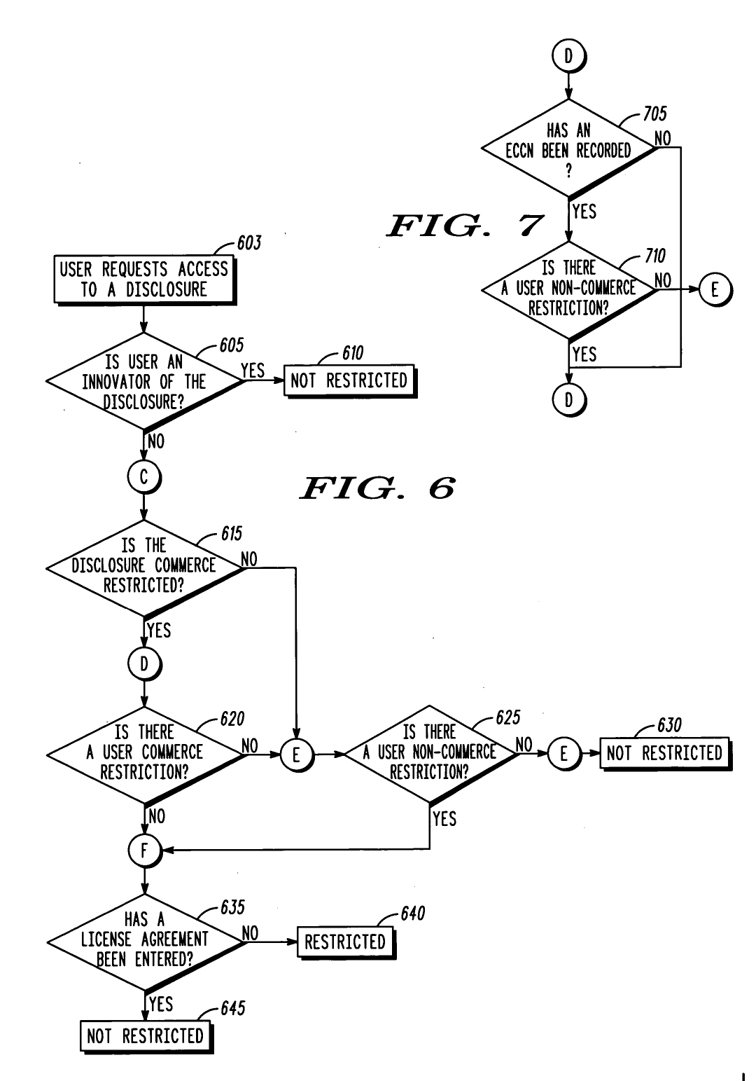

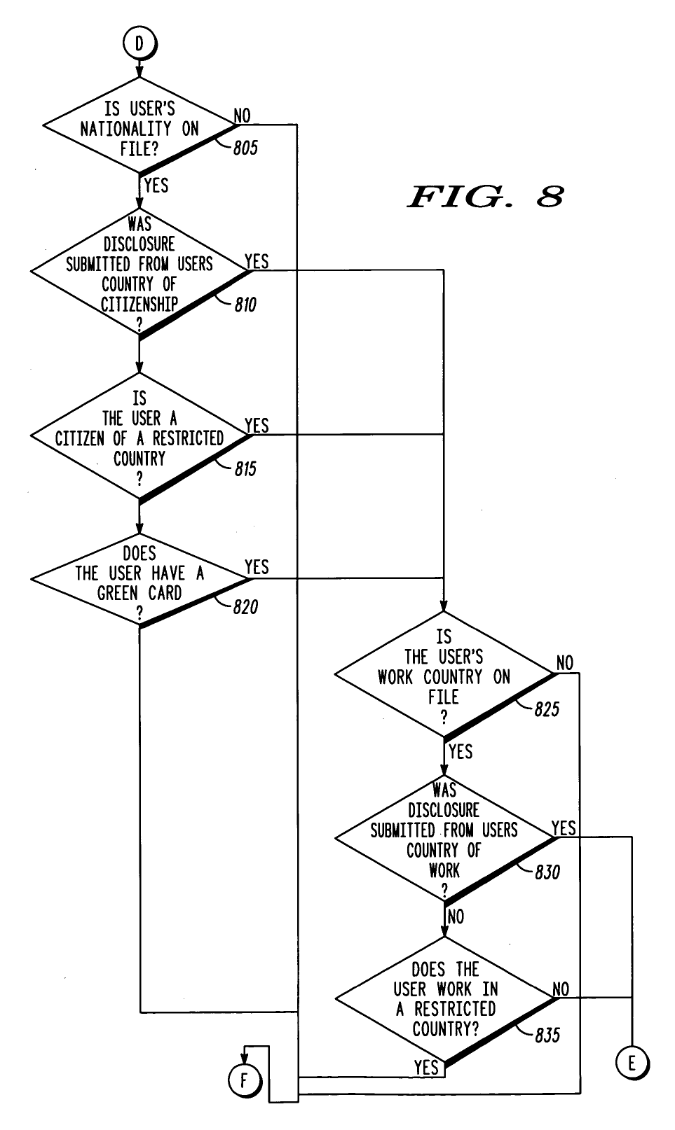

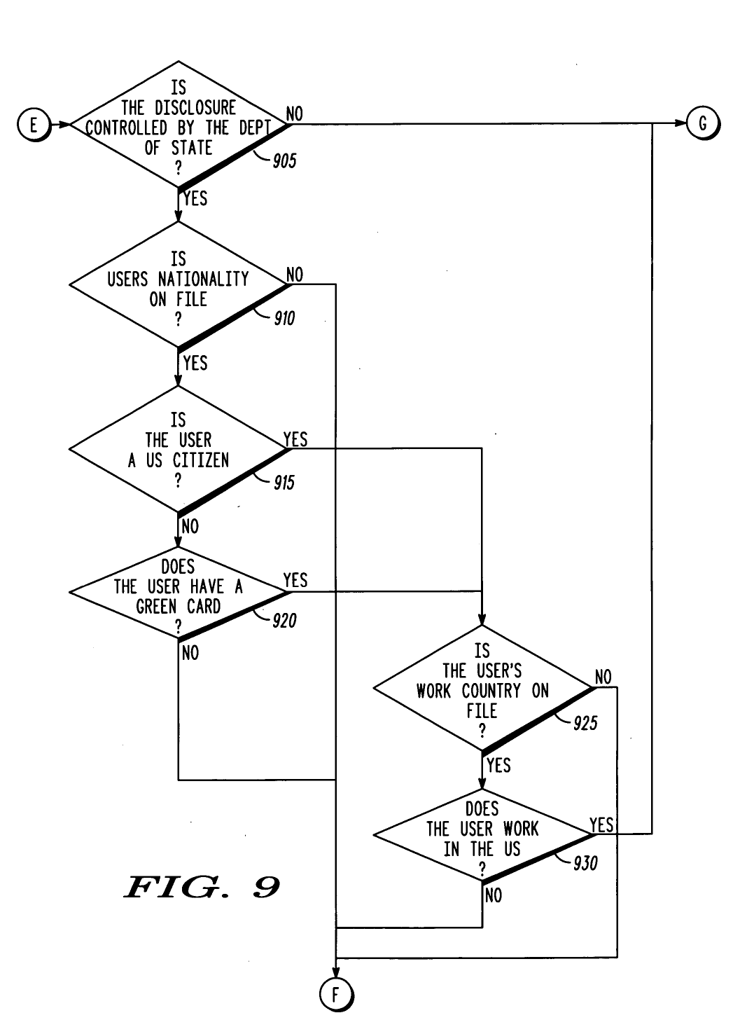

Referring to FIG. 6, a flow chart shows steps of a method used in the CECSOI for determining user export restrictions for an invention disclosure that has been submitted but not entered, in accordance with an embodiment of the present invention. In the context of this description, submitted disclosures includes disclosures that are being drafted. At step 603, a user requests access to an invention disclosure. The user is typically an entry participant, but may be of another type, such as an administrator or attorney. At step 605, the CECSOI determines whether the user is recorded as an innovator on the invention disclosure, and when the user is an innovator on the invention disclosure, the user is recorded by the CECSOI as being not restricted for the invention disclosure at step 610 (i.e., the user does not have an export restriction for the invention disclosure). When the user is not an innovator, then the CECSOI makes a determination of whether the invention disclosure is a commerce restricted invention disclosure at step 615. This determination is described more fully below with reference to FIG. 7. When the invention disclosure is determined to be commerce restricted at step 615, the CECSOI determines at step 620 whether there is a user commerce restriction at step 620, which is described more fully with reference to FIG. 8. When the invention disclosure is determined not to be commerce restricted at step 615 or not to be user commerce restricted at step 620, the CECSOI determines at step 625 whether there is a non-commerce restriction at step 625, which is described more fully with reference to FIG. 9. When there is no non-commerce restriction at step 625, the user is recorded by the CECSOI as non-restricted for the invention disclosure at step 630 (i.e., the user does not have an export restriction for the invention disclosure). When the invention disclosure is determined to be user commerce restricted at step 620 or user non-commerce restricted at step 625, the CECSOI determines at step 635 whether the user has a license for the invention disclosure, and when there is a license the user is recorded by the CECSOI as non-restricted for the invention disclosure at step 645 (i.e., the user does not have an export restriction for the invention disclosure). When no assigned license is found at step 635, the user is recorded by the CECSOI as being restricted for the invention disclosure at step 640 (i.e., the user has an export restriction for the invention disclosure).

The arrangement of the determinations made by the CECSOI that has been described with reference to FIG. 6 is a preferred arrangement, but not necessarily the only one that can lead to the same result. (The same is true for all the flow charts described herein). The result of the above arrangement can be reduced to the following statements: A user non-restriction is recorded (between submission and entry of an invention disclosure) when any one of the following four statements are true:

The user is recorded as being an innovator for the invention disclosure.

The user has a license status recorded that indicates the user is licensed for the invention disclosure.

The invention disclosure is not commerce restricted and there is no user non-commerce restriction for the invention disclosure.

There is no user commerce restriction for the disclosure and there is no user non-commerce restriction for the disclosure.

Referring to FIG. 7, a flow chart of a method for determining whether an invention disclosure is commerce restricted (FIG. 6, step 615) is shown, in accordance with an embodiment of the present invention. At step 705, the CECSOI determines whether any ECCN's are recorded for the invention disclosure. When there is at least one ECCN recorded, the CECSOI determines whether at least one ECCN is export controlled at step 710. When no ECCN's are recorded for the invention disclosure or at least one recorded ECCN is export controlled, CECSOI determines that the invention disclosure is commerce restricted. When at least one ECCN has been recorded for the invention disclosure and none are export controlled, CECSOI determines that the invention disclosure is not commerce restricted.

Referring to FIG. 8, a flow chart of a method for determining whether there is a user commerce restriction for an invention disclosure (FIG. 6, step 620) is shown, in accordance with an embodiment of the present invention. At step 805, the CECSOI determines whether a verified citizenship is recorded for the user; when there is one recorded, the CECSOI determines at step 810 whether the work country recorded for the first innovator of the invention disclosure is the country of the verified recorded citizenship of the user. When no work country is recorded, or a verified citizenship is not recorded, or they do not correspond, then the CECSOI determines at step 815 whether the country of the verified citizenship recorded for the user is also recorded as being a restricted country. When the verified citizenship is not recorded or the restriction status of the country is not recorded, or the country of the verified citizenship is also recorded as being a restricted country, the CECSOI determines at step 820 whether a permanent residency in the primary country is recorded for the user. When the user does not have a permanent residency recorded in the primary country, the CECSOI determines that the user has a commerce restriction for the invention disclosure. When the work country recorded for the first innovator of the invention disclosure is the country of the verified recorded citizenship of the user at step 810, or the country corresponding to the verified citizenship recorded for the user is also recorded as being a non-restricted country at step 815, or a permanent residency in the primary country is recorded for the user, the CECSOI determines at step 825 whether there is a work country recorded for the user the CECSOI; when there is, the CECSOI determines at step 830 whether the work country recorded for the first innovator of the invention disclosure is the work country recorded for the user; when it is not the CECSOI determines at step 835 whether the work country recorded for the user is recorded as a restricted country; when it is, the CECSOI determines that the user has a commerce restriction for the invention disclosure. When there is no work country recorded for the user at step 825, the CECSOI determines that the user has a commerce restriction for the invention disclosure. When the work country recorded for the first innovator of the invention disclosure is the work country recorded for the user at step 830, or when the work country recorded for the user is recorded as a non-restricted country at step 835, the CECSOI determines that the user has no commerce restriction for the invention disclosure.

Referring to FIG. 9, a flow chart of a method for determining whether there is a user non-commerce restriction for an invention disclosure (FIG. 6, step 625) is shown, in accordance with an embodiment of the present invention. At step 905, the CECSOI determines whether a non-commerce export restriction is recorded for the invention disclosure. When none is recorded, the CECSOI determines that there is not a user non-commerce restriction for the invention disclosure. When a non-commerce export restriction is recorded for the invention disclosure at step 905, the CECSOI determines whether there is a verified citizenship recorded for the user at step 910. When there is no verified citizenship recorded for the user, the CECSOI determines that there is a user non-commerce restriction for the invention disclosure. When there is a verified citizenship recorded for the user, the CECSOI determines whether the verified citizenship is that of the primary country at step 915; when it is not, the CECSOI determines whether a permanent residency is recorded for the user in the primary country at step 920; when no such permanent residency is recorded, the CECSOI determines that there is a user non-commerce restriction for the invention disclosure. When at step 915 the CECSOI determines that the verified citizenship is that of the primary country or when at step 920, the CECSOI determines that a permanent residency is recorded for the user in the primary country, the CECSOI then determines whether there is a work country recorded for the user at step 925; when there is, the CECSOI determines whether the work country is the primary country at step 930; when it is, the CECSOI determines that there is no user non-commerce restriction. When there is no work country recorded for the user at step 925 or when the work country is not the primary country at step 930, the CECSOI determines that there is a user non-commerce restriction for the disclosure.

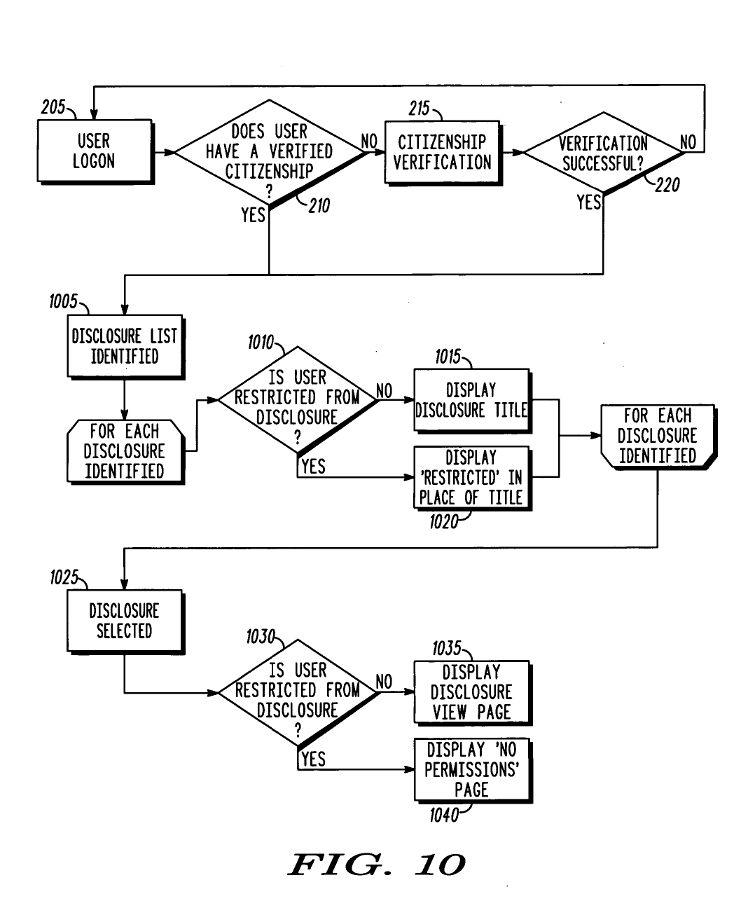

Referring to FIG. 10, a flow chart of a method for presenting invention disclosure information to a user is shown, in accordance with an embodiment of the present invention. Before the user can request information concerning any disclosure that is in the CECSOI, the user must log on and have a verified citizenship recorded in the CECSOI. This activity was described above with reference to FIG. 2 with reference to steps 205-220, which are repeated in FIG. 10. After a successful log on, the user is presented with information and entry means (e.g., type-in fields or selection lists) by which the user identifies at step 1005 a particular list of invention disclosures that the user wishes to review. For each invention disclosure on the list, the CECSOI determines whether a user export restriction is recorded for the invention disclosure at step 1010. Where there is no user export restriction, the title of the invention disclosure is entered into the list, at step 1015. When there is a user export restriction, a phrase indicating that the invention disclosure is restricted is presented instead, at step 1020. At step 1025, the user selects an invention disclosure from the list. The CECSOI determines whether a user export restriction is recorded for the selected invention disclosure at step 1030, and when it is, the CECSOI displays a page or phrase at step 1040 indicating that the selected invention disclosure is restricted (and does not display pages of the invention disclosure). When there is no user export restriction for the invention disclosure, it is presented to the user at step 1035.

In summary, the CECSOI removes a title of an invention disclosure from a list of one or more invention disclosures and prevents the viewing of an invention disclosure when the user is restricted for the invention disclosure.

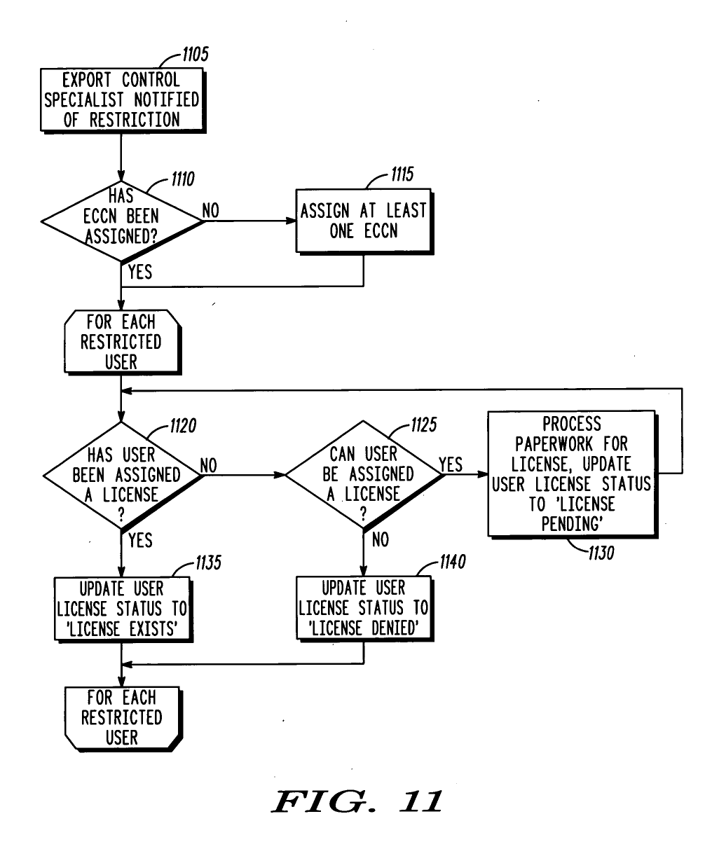

Referring to FIG. 11, a flow chart of a method for an Export Control Specialist to resolve a user export restriction for an invention disclosure is shown, in accordance with an embodiment of the present invention. At step 1105, the Export Control Specialist (ECS) is notified of a user export restriction (such as by email at step 365 of FIG. 3 or step 550 of FIG. 5). As a first step, the ECS learns from the CECSOI what ECCN's have been assigned to the invention disclosure at step 1110, and when none have, the ECS may review the invention disclosure to determine one or more appropriate ECCN's. The ECS enters them and the CECSOI records them for the invention disclosure, at step 1115. When there are already ECCN's assigned or when the ECS enters one or more, there may still be one or more user export restrictions for the invention disclosure. For each user export restriction remaining for an invention disclosure, the ECS determines at step 1120 whether there exists a license outside of the CECSOI system (such as in paper form or a trusted electronic copy not in the CECSOI system), and when one has been verified by the ECS, the license is recorded by the ECS in the CECSOI at step 1135 by changing the status to “exists”. When no such license exists, the ECS determines whether one can be obtained at step 1125, and when it can be, the ECS and user prepare and sign the necessary forms at step 1130 to obtain the license, at which time the ECS can change the status of the license in the CECSOI for the user as “pending”. When the new license is assigned at step 1120, the ECS can then change the status to “exists” at step 1135. When the ECS determines that the user cannot obtain a license in a timely manner, the ECS records the user as not having a license by changing a status to “denied” in the CECSOI.

In the foregoing specification, the invention and its benefits and advantages have been described with reference to specific embodiments. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims.

As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

The term “plurality”, as used herein, is defined as two or more than two. The term “another”, as used herein, is defined as at least a second or more. The terms “including” and/or “having”, as used herein, are defined as comprising. The term “coupled”, as used herein with reference to computer technology, is defined as connected, although not necessarily directly, and not necessarily mechanically, as in a network connection. The term “program”, as used herein, is defined as a sequence of instructions designed for execution on a computer system. A “program”, or “computer program”, may include a subroutine, a function, a procedure, an object method, an object implementation, an executable application, an applet, a servlet, a source code, an object code, a shared library/dynamic load library and/or other sequence of instructions designed for execution on a computer system. A “set” as used herein, means a non-empty set (i.e., for the sets defined herein, comprising at least one member)

1. A method used by an computerized export control system for online information in a primary country, comprising:
allowing log-on by a user to the computerized export control system only when the user has a verified citizenship that is recorded and available to the computerized export control system.

2. The method according to claim 1, further comprising:
presenting a legal consequences alert to the user;
accepting a citizenship selection from the user; and
recording the citizenship selection as the user's verified citizenship.

3. The method according to claim 2, further comprising:
denying an online change of the verified citizenship from a country that is recorded as being restricted to a country that is recorded as being not restricted.

4. The method according to claim 2, further comprising:
requiring the user to identify a permanent residency status in the primary country when the citizenship selection is other than the primary country.

5. The method according to claim 1, wherein the verified citizenship is obtained from a personnel records system.

6. The method according to claim 1, further comprising:
recording a work country of the user that is determined from a business location of the user recorded in a personnel records system.

7. The method according to claim 1, further comprising:
identifying a first user as an Export Control Specialist when the first user's log-on identification matches an identification in a list of Export Control Specialists available to the computerized export control system; and
accepting an alteration of a second user's recorded license status for a document from the Export Control Specialist.

8. A method used in an computerized export control system for online information in a primary country, comprising:
recording an export control classification number (ECCN) for a new document, when a user entered ECCN matches an ECCN on a recorded list of valid ECCN's.

9. The method according to claim 8, further comprising:
providing a selection to the user to indicate whether an exportation of the new document is known to be restricted by the government of the primary country by other than ECCN's, and
recording the selection made by the user.

10. The method according to claim 8, further comprising:
providing at least one field to the user for identifying one or more entry participants when an option of drafting a new document has been selected by the user;
recording the one or more entry participants identified by the user; and
automatically notifying the one or more identified entry participants that the new document is submitted when a draft of a document is submitted by the user.

11. The method according to claim 10, further comprising:
obtaining an identification of a manager of at least one of the one or more entry participants from a personnel records system; and
recording the manager as an entry participant for the new document.

12. The method according to claim 8, further comprising:
permitting user access to a document under when at least one of the following conditions is true
the user is an author of the document,
the document is not commerce restricted and there is no non-commerce restriction for the user for the document, and
the user has an export license for the document.

13. The method according to claim 8, further comprising:
automatically notifying at least one Export Control Specialist when a document is submitted and the document has an export workflow restriction.

14. The method according to claim 13, further comprising:
recording a document as having an export workflow restriction when there is an entry participant that is recorded as having a user export restriction for the document.

15. The method according to claim 8, further comprising:
determining that a document is commerce restricted when no ECCN's are recorded for the document.

16. The method according to claim 8, further comprising:
recording a user as having no user export restriction for a document when the user is recorded as being an author for the document.

17. The method according to claim 8, further comprising:
recording a user as having no user export restriction for a document when the user has a license status recorded that indicates the user is licensed for the document.

18. The method according to claim 8, further comprising determining a user commerce restriction for a document based on at least one of the following criteria:
whether a verified citizenship is recorded for the user;
whether a work country recorded for a first author of the document is the country of the verified recorded citizenship of the user;
whether the country of the verified citizenship recorded for the user is also recorded as being a restricted country;
whether a permanent residency in the primary country is recorded for the user;
whether a work country is recorded for the user;
whether the work country recorded for the first author of the document is the work country recorded for the user; and
whether the work country recorded for the user is recorded as a restricted country.

19. The method according to claim 8, further comprising determining a user non-commerce restriction for a document based on at least one of the following criteria:
whether a verified citizenship is recorded for the user;
whether the country of the verified citizenship of the user is the primary country;
whether a permanent residency in the primary country is recorded for the user;
whether a work country is recorded for the user; and
whether the work country recorded for the user is the primary country.

20. The method according to claim 8, further comprising:
recording a user as having no user export restriction for a document when the document is not commerce restricted and there is no user non-commerce restriction for the document.

21. The method according to claim 8, further comprising:
recording a user as having no user export restriction for a document when there is no user commerce restriction for the document and there is no user non-commerce restriction for the document.

22. The method according to claim 8, further comprising:
removing a title of a document from a list of one or more documents when the user has a user export restriction for the document.

23. The method according to claim 8, further comprising:
preventing a viewing of a document when the user has a user export restriction for the document.

24. The method according to claim 8, further comprising:
recording a status of a document as entered when all entry participants are recorded as having no user export restriction for the document.

25. A method used in an computerized export control system for online information in a primary country, comprising:
recording a document as being commerce restricted when at least one of the following statements is true; no export classification control number (ECCN) is recorded for the document, and at least one recorded ECCN is export controlled.
